(19) United States
(12) Patent Application Publication
(10) Pub. No.: US 2016/0362157 A1
(43) Pub. Date: Dec. 15, 2016

(54) BODY MOTION POWERED RIDE-ON VEHICLE

(71) Applicant: Frederick James McDonald, Des Plaines, IL (US)

(72) Inventor: Frederick James McDonald, Des Plaines, IL (US)

(21) Appl. No.: 15/249,806

(22) Filed: Aug. 29, 2016

Related U.S. Application Data
(60) Provisional application No. 62/245,430, filed on Oct. 23, 2015.

(51) Int. Cl. B62M 1/18; B62K 15/00; B62K 5/00

(52) U.S. Cl. CPC B62M 1/18; B62K 5/00; B62K 15/008

(57) ABSTRACT

A body motion vehicle is provided. The body motion vehicle has a pivotally connected arcuate two-part flexible frame and a tension member also interconnecting the two-part flexible frame so as to be movable between a collapsed condition and an upright condition that the tension member biases the two-part flexible frame thereto. A seat is disposed at the apex of the arcuate two-part flexible frame. The front frame of the two-part frame provides a steering apparatus and footholds so that a rider induces motion through the body motion vehicle by exerting force on the seat, footholds, and steering apparatus as the two-part flexible frame recoils from and is urged to the collapsed condition.

### BACKGROUND OF THE INVENTION

The present invention relates to vehicular toys and, more particularly, to a body motion powered ride-on vehicle.

Current body motion ride-on vehicles lack the ability to keep the rider's interest to utilize the ride-on as they age because they are not designed to accommodate a wide range of ages and sizes of children, as so become short-lived toys. Furthermore, current body motion ride-on vehicles do not promote healthy body activity, but rather add stress to rider's growing bodies.

As can be seen, there is a need for a body motion powered ride-on vehicle powered by body motion, facilitating non-stressful body activity and exercise. The present invention is designed to be easily and safely operated, to promote healthy physical enjoyment, to accommodate a wide range of ages and sizes of children and to create a lasting desire to ride, so as to outlast the eventual growth and change of a child's ability to utilize the present invention, as they transition to other vehicles as they get older.

### SUMMARY OF THE INVENTION

In one aspect of the present invention, a body motion ride-on vehicle includes an arcuate front frame extending from a front distal end to a front pivotal end, wherein a front mounting point is disposed between the front distal and pivotal ends; an arcuate rear frame extending from a rear distal end to a rear pivotal end, wherein a rear mounting point is disposed between the rear distal and pivotal ends; a pivotal connection interconnecting the front and rear pivotal ends so that the front and rear frames are movable between an upright condition and a collapsed condition; a steering apparatus having a steering shaft; wherein the steering shaft is rotatably connected to the front distal end; and a tension member interconnecting the front and rear mounting points, so that the front and rear frames are biased in the upright condition.

In another aspect of the present invention, the body motion ride-on vehicle includes an arcuate front frame extending from a front distal end to a front pivotal end, wherein a front mounting point is disposed between the front distal and pivotal ends; an arcuate rear frame extending from a rear distal end to a rear pivotal end, wherein a rear mounting point is disposed between the rear distal and pivotal ends; a pivotal connection interconnecting the front and rear pivotal ends so that the front and rear frames are movable between an upright condition and a collapsed condition; a sleeve provided by the front distal end; a steering shaft extending from a steering apparatus to a front axle, wherein the steering shaft is rotatably and laterally connected through the sleeve; a tension member interconnecting the front and rear mounting points, so that the front and rear frames are biased in the upright condition; opposing footholds provided by the front distal end; a seat connected to the front and rear pivotal ends; and a rear axle joined to the rear distal end; a rear wheel rotatably connected to each of the opposing ends of the rear axle; and a front wheel rotatably connected to each of the opposing ends of the front axle.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a rear perspective view of an exemplary embodiment of the present invention;

FIG. 3 is a section view of an exemplary embodiment of the present invention, taken along line 3-3 in FIG. 2;

FIG. 4 is a section view of an exemplary embodiment of the present invention;

FIG. 5 is a section view of an exemplary embodiment of the present invention;

FIG. 6 is an exploded view of an exemplary embodiment of the present invention; and

FIG. 7 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a body motion vehicle having a pivotally connected arcuate two-part flexible frame and a tension member also interconnecting the two-part flexible frame so as to be movable between a collapsed condition and an upright condition that the tension member biases the two-part flexible frame thereto. A seat is disposed at the apex of the arcuate two-part flexible frame. The front frame of the two-part frame provides a steering apparatus and footholds so that a rider induces motion through the body motion vehicle by exerting force on the seat, footholds, and steering apparatus as the two-part flexible frame recoils from and is urged to the collapsed condition.

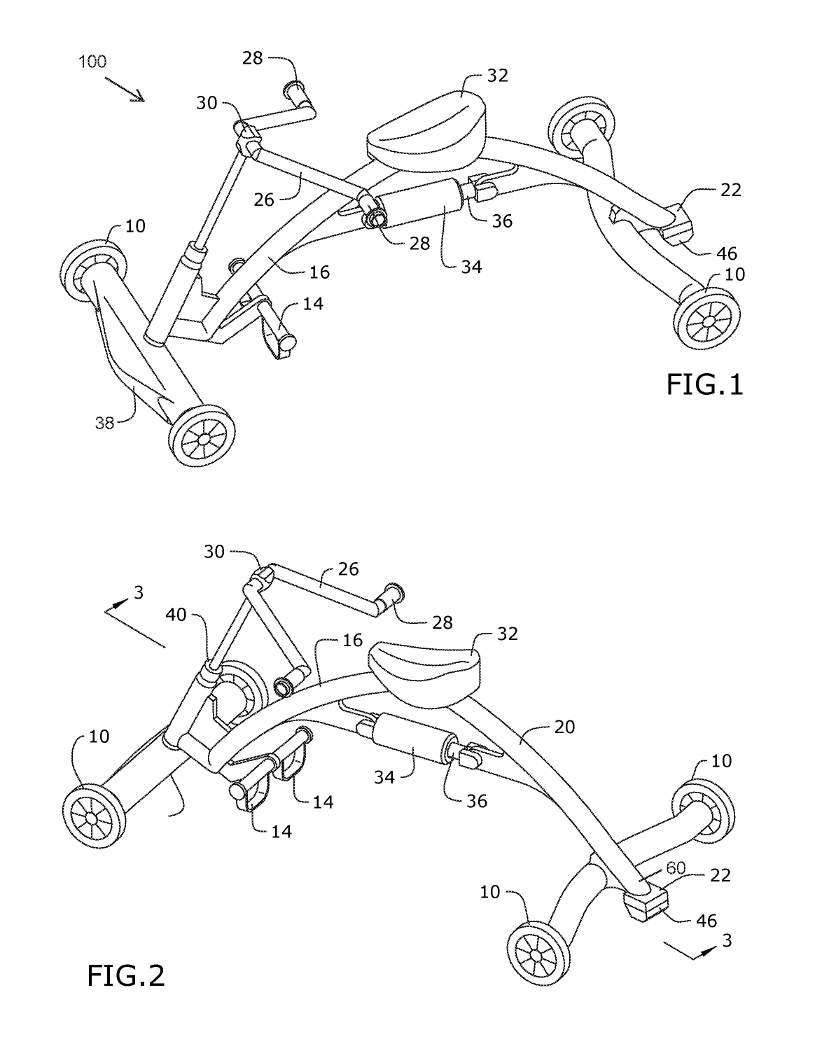

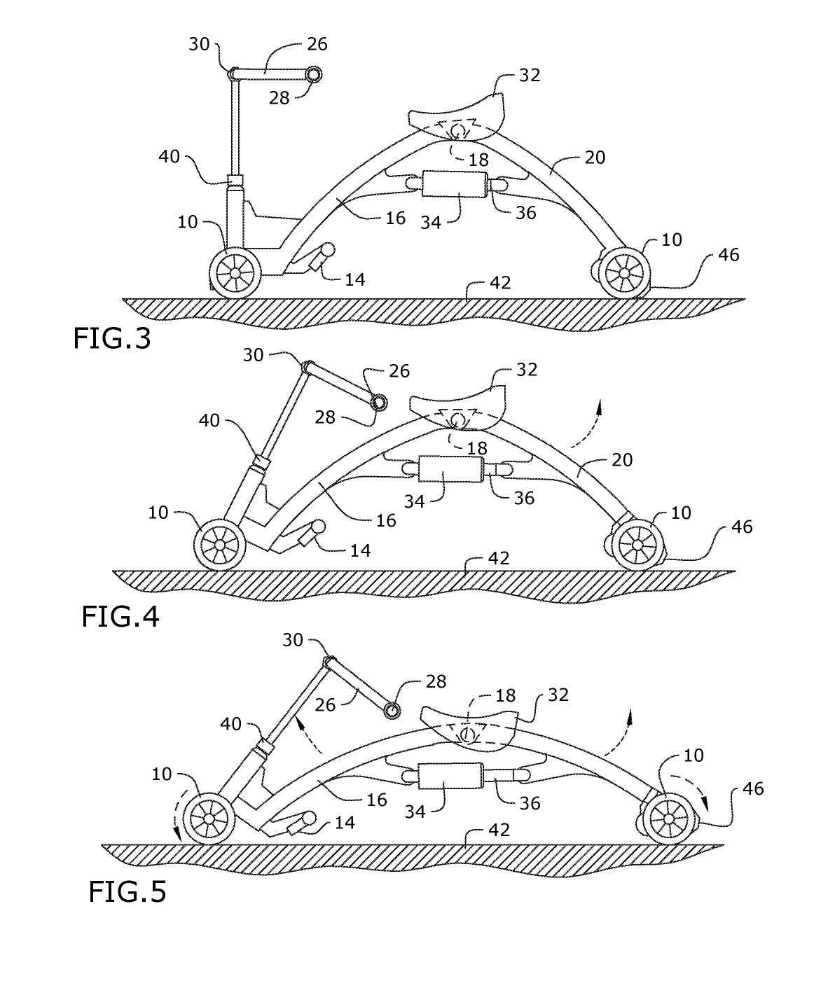

Referring to FIGS. 1 through 7, the present invention may include a body motion vehicle 100 having a pivotally connected two-part flexible frame, shock absorber interconnecting said two-part flexible frame, and footholds for enabling motion. The body motion vehicle 100 may include a front frame 16 and a back frame 20 interconnected by a pivotal connection 18. Each frame 16, 20 may extend in a non-linear fashion from a pivotal end to a distal end. Each pivot end of each frame 16, 20 may provide a pivot aperture. The pivot ends may be adapted to complementarily mate together so that each respective pivot aperture aligns. In certain embodiments, the pivot ends may provide tines adapted to nest when complementarily mating. In certain embodiments, the pivotal connection 18 may include a pivot pin disposed through the aligned complementary pivot apertures, as illustrated in FIGS. 3-7.

When complementarily mated, the frames 16, 20 form an arcuate shape, wherein the distal ends are disposed nearer the supporting surface 42 during use. Disposed near the apex of said arcuate shape, a seat 32 may be provided. The seat 32 may be connected to said apex by the same pivotal connection 18, wherein some embodiments the seat 32 is not pivotally connected to the apex. The seat 32 may provide at least one seat aperture that aligns with the other pivotal apertures during complementary mating. Similar to the pivotal ends, the seat 32 may provide spaced apart tines for nested mating.

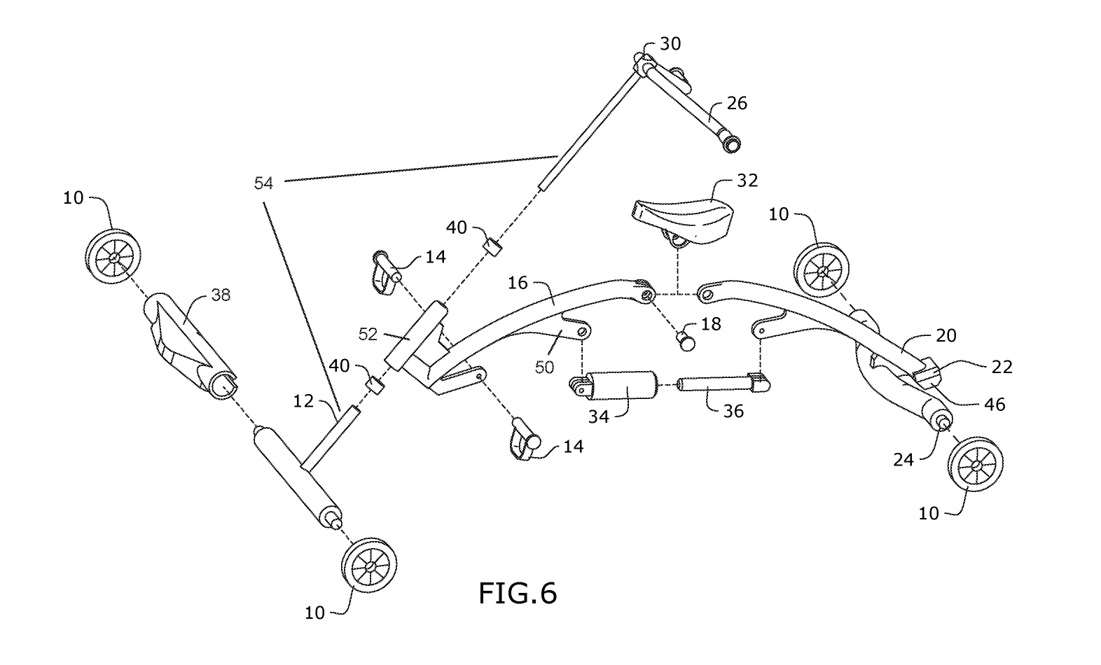

A mount point 50 may be provided near midpoint of each frame 16 and 20 so that the mounting points 50 are opposing each other, as illustrated in FIG. 6. Interconnecting each mounting point 50 may be a tension member 36. The tension member 36 may be a spring or other member that provides sufficient elastic tension between the opposing mounting points 50 so as to bias the front and rear frames 16 and 20 in an upright condition, as illustrated in FIG. 3, wherein the front and rear frames 16 and 20 are movable between the upright condition and a collapsed condition, FIGS. 4 and 5, upon sufficient urging. A member housing 34 may be provided to slidably receive the tension member 36 in the upright condition, as well as provide the tension member 36 with shock absorbing properties.

The front distal end may be rotatably connected to a steering shaft 54. In certain embodiments a sleeve 52 for receiving the rotatable steering shaft may be provided by the front distal end. The steering shaft 54 may be connected to a steering apparatus 26 and a front axle 12 on opposing ends of the steering shaft 54 respectively. In certain embodiments, the steering apparatus 26 may be handle bars, wherein the handle bars are connected to the steering shaft 54 by a clamp 30, and wherein the handle bars provide handle grips 28. In certain embodiments, the steering shaft 54 may be two separate shafts, one joined to the steering apparatus 26 and the other joined to the front axle 12, that are operably combined within the sleeve 52 with the assistance of, in certain embodiments, opposing rings 40. The sleeve 52 also enables lateral forces to be urged on the front frame 16 through the manipulation of steering shaft/apparatus 54/26.

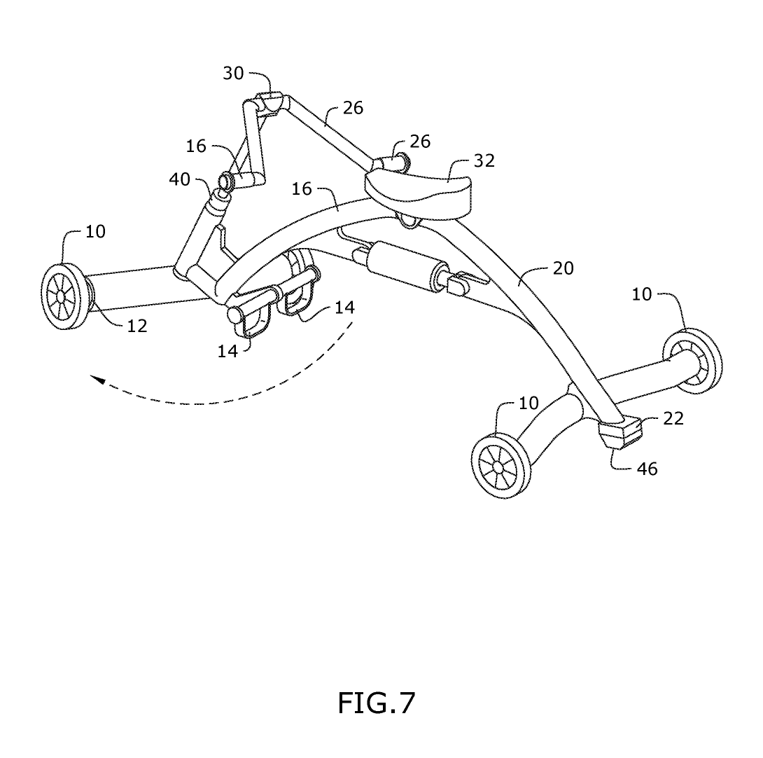

The rotation of the steering shaft 54 through the manipulation of the steering apparatus 26 enables a rider to control the side to side movement of the front axle 12, as illustrated in FIG. 7. The front axle 12 may terminate in opposing rotatably connected front wheels 10. In certain embodiments, the front axle 12 may be partially housed in an axle housing 38.

The rear distal end may be connected to a rear axle 24. The rear axle 24 may terminate in opposing rotatably connected rear wheels 10. The rear distal end may provide a protrusion 60 that extends beyond the rear axle 24 toward the supporting surface 42. The protrusion may terminate in a kick-foot 46. The kick-foot 46 may be made of rubber or the like. In certain embodiments, there may be a pad housing 22 interconnecting the protrusion 60 and the kick-foot 46. The kick-foot 46 may be adapted to operate in the same manner an individual's foot would operate when riding a scooter. In certain embodiments, when the weight is distributed upon the seat 32, the two part frame collapses causing the rear frame 20, (the rubber kick-foot in specific), to strike the supporting surface 42 and propel the ride forward. As the rider reduces his/her weight, the two-part flexible frame recoils and positions the kick-foot 46 to strike the supporting surface 42 again. The quicker the rider bounces collapsing the frame, the more the rubber kick-foot 46 strikes the supporting surface 42 propelling the vehicle faster. As the rider reduces distributed weight and the number of bounces, the vehicle's kick-foot 46 strikes the supporting surface 42 less and slows its forward progress.

The front distal end provides opposing footholds 14, such as stirrup, flanges and/or the like for accommodating a rider's feet when the user is seated on the seat 32 as well as for enabling the rider to apply force to the front frame 16 through their feet. In certain embodiments, the seat 32 may provide a cushion. The seat 32 and tension element 36 may be adjusted to comfortably accommodate the size and weight of the rider.

A method of using the present invention may including the following. The body motion vehicle 100 disclosed above may be provided. Without force, the rider may sit on the seat 32 and takes a firm grip on the steering apparatus 26. The rider's feet may be then securely engage the opposing footholds 14. The rider then forcibly distributes weight on the seat 32, while simultaneously pulling the steering apparatus 26 backwards toward their person, and pushing the feet forward propelling the body motion vehicle 100 forward. To increase speed, the rider would increase the body motions at a faster pace continuously. To decrease speed or stop the vehicle, the rider would simply slow or halt all body motions. The tension member 36 may be adapted to securely stabilize the abovementioned scissor motion, wherein the rider's weight and body motion selectively operates the body motion vehicle 100. The tension member 36 may act as a shock absorber to absorb and control the distributed weight, while allowing the front and rear frames 16 and 20 to move between the collapsed condition and the upright condition under urging of a rider's feet and the recoil urging of the tension member's biasing, respectively.

During such scissor motion, as illustrated in FIGS. 3-5, the front and rear frames 16 and 20, by being separate pivotally connected members, are able to move from the upright condition, FIG. 3, to the collapsed condition FIGS. 4 and 5. In the upright condition, the steering shaft 54 may be approximately perpendicular relative to the supporting surface 42. The scissor-collapsing movement, wherein the front and rear frames 16 and 20 move away from each other, enables the front and rear wheels 10 to rotate in opposing direction, further enabling forward motion in conjunction with the footholds 14. The footholds 14 may be needed to support the feet as well as assisting in opening the frame to the collapsed condition as much as the steering apparatus 26 may be needed to guide the vehicle, and as the seat 32 may be needed to sit comfortably while riding the vehicle.

The rider will likely adjust the seat 32 for riding comfortably before sitting, firmly take control of the steering apparatus 26, and then place the feet in the front footholds 14. The rider could begin by exerting body motion by gently rising off the seat 32 and then distributing weight by forcibly sitting on the seat 32, while simultaneously pulling the steering apparatus 26 backwards, and pushing the footholds 14 forward creating forward motion. To make the vehicle travel faster, the rider would then exert more force by rising and sitting at a quicker pace. To make left and right turns, the rider will simply turn the steering apparatus 26 in the desired direction. To slow or stop the ride-on, the rider simply reduces the force exerted on the seat 32, footholds 14, and steering apparatus 26.

It should be understood, of course, that the foregoing relates to exemplary embodiments of the invention and that modifications may be made without departing from the spirit and scope of the invention as set forth in the following claims.

What is claimed is:

1. A device, comprising:
an arcuate front frame extending from a front distal end to a front pivotal end, wherein a front mounting point is disposed between the front distal and pivotal ends;
an arcuate rear frame extending from a rear distal end to a rear pivotal end, wherein a rear mounting point is disposed between the rear distal and pivotal ends;
a pivotal connection interconnecting the front and rear pivotal ends so that the front and rear frames are movable between an upright condition and a collapsed condition;
a steering apparatus having a steering shaft; wherein the steering shaft is rotatably connected to the front distal end; and
a tension member interconnecting the front and rear mounting points, so that the front and rear frames are biased in the upright condition.

2. The device of claim 1, further comprising opposing footholds provided by the front distal end.

3. The device of claim 1, wherein the steeling shaft is also laterally connected to the front distal end.

4. The device of claim 3, further comprising a sleeve for rotatably and laterally connecting the steering shaft to the front frame.

5. The device of claim 1, further comprising a seat connected to the front and rear pivotal ends.

6. The device of claim 1, further comprising a front axle joined to the steering shaft on an end thereof opposing the steering apparatus, and further comprising a front wheel rotatably connected to each of the opposing ends of the front axle.

7. The device of claim 1, further comprising a rear axle joined to the rear distal end, and further comprising a rear wheel rotatably connected to each of the opposing ends of the rear axle.

8. A device, comprising:
an arcuate front frame extending from a front distal end to a front pivotal end, wherein a front mounting point is disposed between the front distal and pivotal ends;
an arcuate rear frame extending from a rear distal end to a rear pivotal end, wherein a rear mounting point is disposed between the rear distal and pivotal ends;
a pivotal connection interconnecting the front and rear pivotal ends so that the front and rear frames are movable between an upright condition and a collapsed condition;
a sleeve provided by the front distal end;
a steering shaft extending from a steering apparatus to a front axle, wherein the steering shaft is rotatably and laterally connected through the sleeve;
a tension member interconnecting the front and rear mounting points, so that the front and rear frames are biased in the upright condition;
opposing footholds provided by the front distal end;
a seat connected to the front and rear pivotal ends; and
a rear axle joined to the rear distal end;
a rear wheel rotatably connected to each of the opposing ends of the rear axle; and
a front wheel rotatably connected to each of the opposing ends of the front axle.
